(19) United States
(12) Patent Application Publication
(10) Pub. No.: US 2007/0118827 A1
(43) Pub. Date: May 24, 2007

(54) Method and apparatus for integrated circuit fault isolation and failure analysis using linked tools cockpit

(76) Inventor: Asifur Rahman, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/285,403

(22) Filed: Nov. 21, 2005

(51) Int. Cl. G06F 17/50

(52) U.S. Cl. 716/11; 716/4

(57) ABSTRACT

A microelectronic circuit debugging environment links development tools by correlating a selected element in a first tool with elements in the datasets of other tools. A signaling module instructs the other tools to display the correlated elements.

### FIELD OF THE INVENTION

The invention relates to design, simulation and debugging of microelectronic circuits. More specifically, the invention relates to synthesizing an integrated environment for developing microelectronic circuits.

### BACKGROUND

Demand for expanded functionality, increased speed and reduced power consumption of electronic devices drives microelectronic circuit manufacturers to produce ever-smaller, ever-more-complex integrated circuits. Circuits are often produced at or near the limits of current technology: device sizes are reduced, voltages are lowered, and circuit areas are increased. These trends place demands on the tools used throughout the design, manufacturing, testing and debugging process. For example, layout tools must manage more structures in larger areas, simulation tools must track more signals with a greater range of possible propagation delays, and chip debugging tools must resolve smaller structures and shorter pulses. However, in addition to the increased demands placed on individual tools in the tool-chain, the increased complexity demands improved inter-domain coordination.

Presently-used tools, such as Gatevision® from Concept Engineering GmbH for viewing circuit schematics; Merlin's Framework™ from Knights Technology™ for chip layout; CSim from Intel Corporation and other similar tools for simulating register transfer logic (“RTL”) models; and pico-probing tools and microscopes for examining physical circuits; lack effective correlation capabilities, so that an engineer may have difficulty determining, for example, what signal an observed broken conductor carries, and what effect the lost signal might have on the expected simulation results. A system to link tools and coordinate data from various design and debug domains may be of significant value to microelectronics manufacturers.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows relationships between debug domains, and how various engineering tools display data from these domains.

FIG. 2 is a flow chart of consolidation tool operations according to an embodiment of the invention.

FIG. 3 shows logical blocks and relationships found in some embodiments.

FIG. 4 shows an example system environment within which an embodiment may be used.

### DETAILED DESCRIPTION

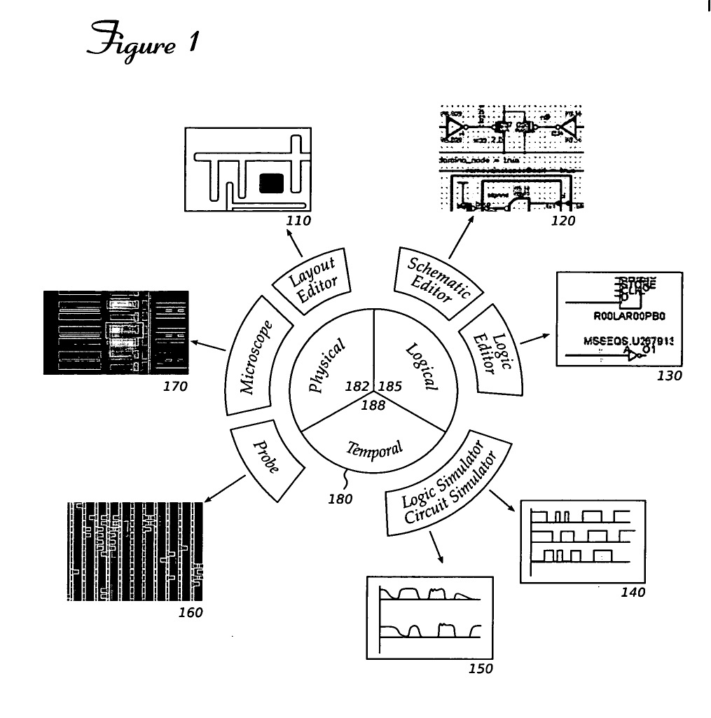

A design or debug “domain” is a set of data about an aspect of an apparatus or process. Complex devices and processes can often be examined from several perspectives, and design or debug tools are typically tuned to present information from only one or two perspectives. This is shown in FIG. 1, where, for example, a microelectronic circuit can be viewed as a (thin) three-dimensional structure (110) using a layout editor; as an idealized electronic circuit (120) using a schematic editor; as a logic network (130) using a logic editor; or as a set of circuit (140) or logic (150) simulation results using circuit or logic simulators. A physical instance of the circuit can be tested with electronic probes and the signals recorded and displayed (160), and the semiconductor die itself can be viewed under a microscope (170). The total information available (180) may be broadly divided into the physical (182) (where things are), logical (185) (what things are), and temporal (188) (when things change).

Each tool's view of the overall set of information can be correlated with some of the other tools'views through one or more common parameters. For example, a structure depicted graphically in a layout editor may correspond to a transistor in the schematic view or to a specific area of a semiconductor die that can be viewed under the microscope. Some pairs of tools, however, may not share common parameters between their views of the overall data set. For example, a logic simulator may have no use for physical location information available in the views of the layout editor and microscope. Nevertheless, correlations through an intermediate tool's view can still be made: a structure at a particular physical location of a semiconductor corresponds to a transistor in the circuit schematic, which is part of a logic gate, the output of which may be viewed in the logic simulator.

During the development of a microelectronic circuit design, engineering tasks tend to be reasonably well-partitioned with respect to the data perspective necessary to perform the task. Thus, for example, a designer adjusting the shape of a transistor to fit within a constrained area would be unlikely to refer to a simulation trace to see whether the transistor is on or off at a particular point in time, while an engineer analyzing a circuit timing diagram would not need to know whether a trace carrying a signal was oriented horizontally or vertically. This partitioning provides several benefits: tools can be simpler, since they need not display or account for irrelevant information; and manufacturers can upgrade or replace tools piecemeal as better ones become available.

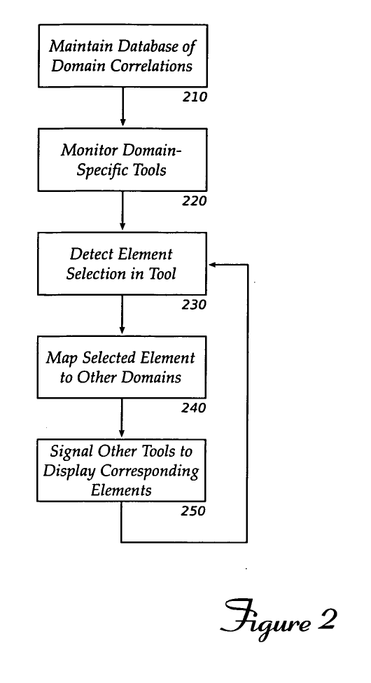

Unfortunately, the same modularity that is useful in circuit design hinders circuit debugging. When analyzing a defective die, an engineer is very likely to move between domains frequently, so permitting fast, accurate perspective shifts can significantly improve debugging outcomes. An embodiment of the invention, operating generally according to the flowchart of FIG. 2, can assist an engineer by maintaining a database of domain correlations (210), monitoring a plurality of domain-specific tools (220), detecting if an element is selected in one tool (230), mapping the selected element to a corresponding element in other domain-specific tools (240), and signaling the other tools to display the corresponding elements (250).

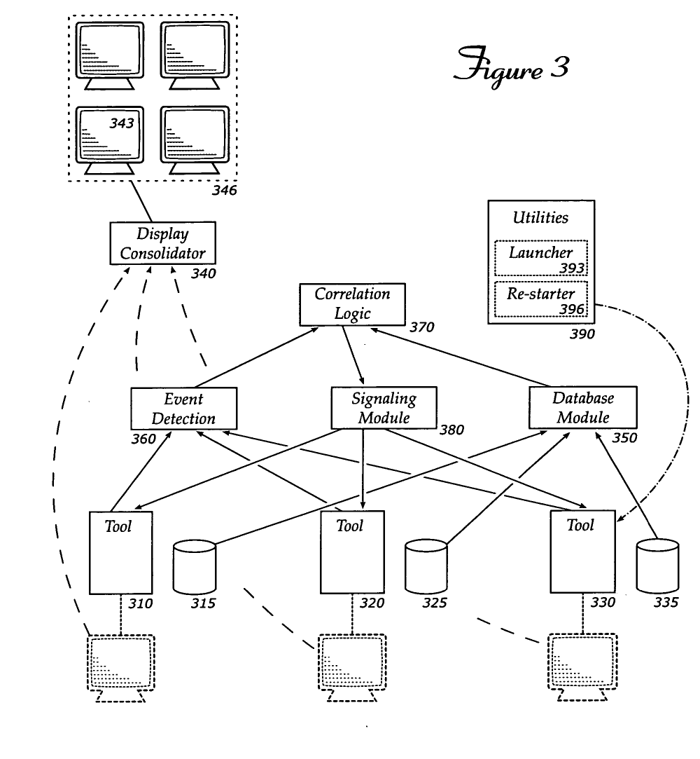

FIG. 3 shows a number of logical modules that may be combined in an embodiment of the invention. The modules interact with a plurality of development tools 310, 320, 330, each of which may have a separate database 315, 325, 335, to contain information describing the tool's view of the device. Tools may be, for example, a Knights layout viewer, an OPUS/nVD schematic editor, an RTL Data behavioral model, a CSIM resistor-transistor logic (“RTL”) simulator, or an infrared microscope. Each tool may have its own display and may run under a different operating system or on a separate system. However, an embodiment of the invention can include a display consolidator 340 to redirect or duplicate the displays of each tool to a single monitor 343. Some embodiments may take advantage of a multi-screen (“multi-head”) system to display information from the tools on a group of coordinated screens 346.

An embodiment will include a database module 350 to access the datasets of the tools. Some tools may provide an export function to make their data more readily available to external programs. When available, standard data formats can reduce the complexity of interfacing with proprietary databases.

An event detector 360 is provided to monitor operations of the development tools and to detect when a user selects an element through a tool's interface. The detector may analyze the selection or interrogate the tool to identify the selected element. Then, the selection is passed to correlation logic 370, which refers to relational rules and information gathered by the database module to map the selected element to corresponding elements in the domains of other tools. Finally, the signaling module 380 causes the other tools to alter their displays to show the corresponding elements.

Some embodiments will also provide utility functions 390 to streamline the debugging process. For example, a function to launch all the linked tools automatically (393) can save a considerable amount of time when the tools must normally be executed on different machines located at various places around a facility, and a function to monitor and restart tools that have crashed (396) can help to prevent interruptions to a debugging session.

From the user's perspective, an embodiment of the invention causes the plurality of independent tools to operate in concert, so that the selection of a structure in the view provided by one tool adjusts the views of the other tools to show, as nearly as possible, the same element. For example, selecting a signal transition in a logic simulation may cause a layout editor to highlight the interconnect carrying the signal, a pico-probing tool to show the actual signal at the time the transition is expected, and a microscope to zoom and/or pan to show the signal source or destination. Similarly, selecting a point on the microscope display may cause the layout editor to show the expected structure, a circuit editor to show the schematic, and an electrical simulator to show the signals expected at the selected node.

When taken all together, functions of an embodiment of the invention streamline the debugging process. This is important not only because of the time saved by automation, but also because debugging often requires fluid, intuitive direction of inquiry. Administrative tasks such as logging in to various systems on a network and adjusting permissions and connections so that required resources are accessible can interrupt an engineer's train of thought and significantly impede progress.

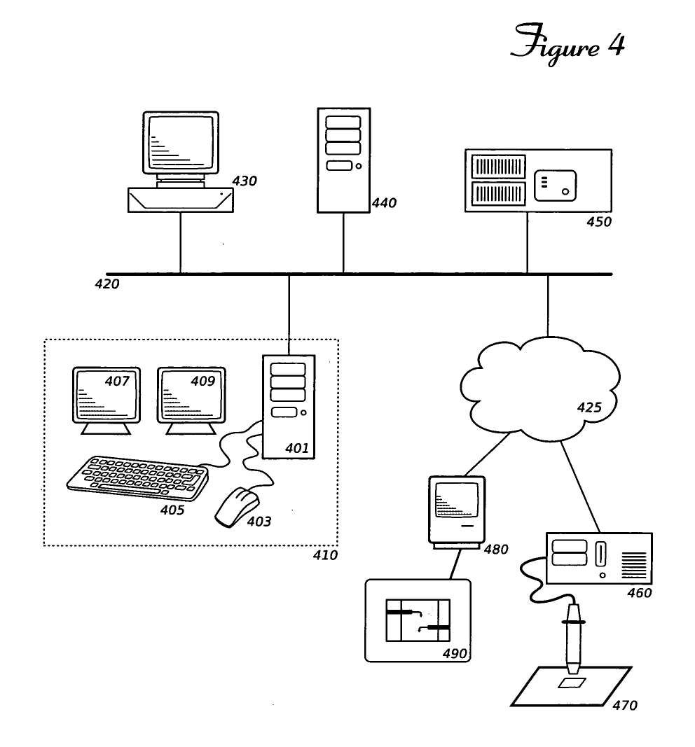

FIG. 4 shows an environment in which an embodiment of the invention can link multiple design, development, and diagnostic tools. 410 is a computer system, including a main unit 401, input devices mouse 403 and keyboard 405, and two monitors 407 and 409. An engineer can interact with other parts of the environment through system 410.

System 410 can communicate with domain-specific tools on other machines through network 420. Tools may be located at any physical distance from system 410 as long as data can be exchanged over the network. For example, tools 460 and 480 are at a location remote from system 410, and communicate in part over a wide-area network such as the Internet 425.

Tools 430, 440, 450, 460 and 480 may run on independent systems, or some tools may be consolidated onto a single system. Systems may implement heterogeneous operating environments. Some tools may run on dedicated, single-purpose hardware, while others may be useable on a general-purpose computer. Any of the tool systems may be run without a monitor (“headless”), since the tool displays are collected and presented to the engineer working at system 410 by a display consolidator.

Some tools may work entirely on abstract data. For example, layout editor 430, schematic editor 440 and logic simulator 450 may be applications that do not require any special hardware facilities to perform their functions. In contrast, software on system 460 controls microscope 470 and acquires images of a sample microelectronic circuit, while an application on system 480 controls probing fixture 490 to inject and monitor signals. Data from many types of tools can be consolidated and displayed to a user at system 410, and the user can use input devices such as mouse 403 and keyboard 405 to interact with the tools. An embodiment of the invention may ensure that user inputs, such as a selection of an element in one tool, are transmitted to the system hosting the tool in an appropriate form to cause the tool to perform the desired action. If the user performs a predetermined action, such as selecting or highlighting an element, an embodiment of the invention can locate corresponding elements in the domains of other tools and signal the other tools to perform a similar highlighting or selection of the corresponding elements.

An embodiment of the invention may be a machine-readable medium having stored thereon instructions which cause a processor to perform operations as described above. In other embodiments, the operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), including but not limited to Compact Disc Read-Only Memory (CD-ROMs), Read-Only Memory (ROMs), Random Access Memory (RAM), Erasable Programmable Read-Only Memory (EPROM), and a transmission over the Internet.

The applications of the present invention have been described largely by reference to specific examples and in terms of particular allocations of functionality to certain hardware and/or software components. However, those of skill in the art will recognize that consolidation of domain-specific data presentation for debugging can also be produced by software and hardware that distribute the functions of embodiments of this invention differently than herein described. Such variations and implementations are understood to be apprehended according to the following claims.

1. An apparatus comprising:
a database module to access a plurality of datasets of a plurality of development tools;
an event detector to detect when a user selects an element through a user interface of a first development tool;
correlation logic to map the selected element to a corresponding element of a second development tool; and
a signaling module to cause the second development tool to display the corresponding element.

2. The apparatus of claim 1, further comprising:
a display consolidator to redirect or duplicate a display from one of the plurality of development tools on a monitor.

3. The apparatus of claim 1, further comprising:
a utility module to launch the plurality of development tools automatically.

4. The apparatus of claim 1, further comprising:
a utility module to monitor the plurality of development tools and to restart a tool that terminates unexpectedly.

5. The apparatus of claim 1 wherein the plurality of development tools comprises at least two of a layout editor, a schematic editor, a circuit simulator, a logic simulator, a probing tool and a microscope.

6. A method comprising:
monitoring an operational state of a plurality of domain-specific tools;
detecting if an element of a first one of the tools is selected;
mapping the selected element to a corresponding element of a second one of the tools; and
signaling the second one of the tools to display the corresponding element.

7. The method of claim 6, further comprising:
mapping the selected element to a corresponding element of at least one additional domain-specific tool; and
signaling the at least one additional tool to cause the tool to display the corresponding element.

8. The method of claim 6 wherein the plurality of domain-specific tools comprise at least two of a schematic editor, a resistor-transistor-logic (“RTL”) simulator, a microelectronic circuit layout editor, an electrical signal probing tool, and a microscope.

9. A system comprising:
a plurality of applications to display data from at least three domains;
an input device to select an element displayed by a first one of the applications;
correlation logic to identify elements related to the selected element in a second one of the applications; and
a signaler to cause the second application to display the related elements.

10. The system of claim 9, further comprising at least one of:
an optical microscope and an electrical signal tester.

11. The system of claim 10 wherein the optical microscope is an infrared microscope.

12. A machine-readable medium containing instructions that, when executed by a processor, cause the processor to perform operations comprising:
detecting a predetermined user action;
identifying an element in a display of a first application that is affected by the user action;
correlating the element with a second element in a dataset of a second application; and
transmitting a message to cause the second application to select or highlight the second element.

13. The machine-readable medium of claim 12, wherein
transmitting the message is to cause a microscope to display an image of a selected portion of a microelectronic circuit.

14. The machine-readable medium of claim 12, wherein
transmitting the message is to cause a resistor-transistor logic (“RTL”) simulator to display a simulation of a selected signal.

15. The machine-readable medium of claim 12, wherein
transmitting the message is to cause a microelectronic circuit layout editor to display a design of a selected structure.

16. The machine-readable medium of claim 12, wherein
transmitting the message is to cause a schematic editor to display a selected portion of a circuit.
